(19) United States
(12) Patent Application Publication
(10) Pub. No.: US 2009/0197032 A1
(43) Pub. Date: Aug. 6, 2009

(54) MULTI-LAYER SHEET AND METHOD OF MANUFACTURING SAME

(75) Inventors: Miguel Jensen DIDULO, London (CA); Michael Bernard WOYCHESHEN, Richmond (CA); Craig GRIFFITHS, Surrey (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: ILLEN PRODUCTS LTD., Richmond (CA)

(21) Appl. No.: 12/024,850

(22) Filed: Feb. 1, 2008

(51) Int. Cl. B32B 7/14; B32B 37/26; G09F 3/02; B32B 38/04

(52) U.S. Cl. 428/41.6; 428/41.8; 428/68; 428/195.1; 428/352; 156/269

(57) ABSTRACT

This application relates to a multi-layer sheet suitable for printer infeed comprising a liner sheet and a label sheet. The sheets are bonded together with a dry release coating. The coating may comprise, for example a dry adhesive or the combination of a breakaway coating and an adhesive. In one embodiment the label sheet is formed of transparent plastic and is cut to define a plurality of labels. When a label is removed from the liner sheet, the adhesive remains on the liner sheet and the label is non-tacky Similarly, since the adhesive is quick drying or coated, the dry release coating ensures that the exposed liner layer 12 is also non-tacky after a label is removed. This permits the multi-layer sheet to be fed through a printer multiple times, even after some labels have been removed. For example, labels may be selectively printed with indicia such as the name or title of an employee or a corporate logo and the printed labels may then be used as part of a wearable name tag assembly. Each sheet is sufficiently flexible and heat-stable that it will not deform if passed through a printer multiple times.

### TECHNICAL FIELD

This application relates to a multi-layer sheet and method of manufacturing same.

### BACKGROUND

Multi-layer mailing label sheets are known in the prior art. One problem with traditional multi-layer sheets is that once the adhesive liner is exposed (e.g. by removable of selected labels), the sheet cannot be passed through a laser printer. This poses a problem if a user wishes to print and use only selected labels (and save the other blank labels for printing at some future date). Plastic labels are relatively expensive as compared to paper labels which exacerbates the problem.

United States Patent Application Publication No. 2004/0091659 dated 13 May 2004 exemplifies the prior art. This application describes an identification badge construction including a facestock releasably adhered to a liner sheet. The construction further includes at least one weakened separation line through the facestock sheet defining one or more labels. The adhesive applied to each label allows the label to be applied to another surface once it is removed from the liner sheet.

Transparent paper label sheets are also known in the prior art. U.S. Pat. No. 5,407,718, Popat et al., describes a label sheet assembly including a backer sheet having a release coating and a substantially transparent paper label sheet. A heat-stable pressure sensitive adhesive is applied to the label sheet. Thus, although the Popat et al. labels are transparent, they are also coated with an adhesive so that the labels may be applied to another surface.

In some cases it is desirable to produce customizable labels or tags which are non-adhesive. As described in the Applicant's U.S. Pat. No. 6,726,252 issued 27 Apr. 2004, which is hereby incorporated by reference, adhesive-free identifier tag assemblies wearable on articles of clothing are known. As described in the '252 Patent, each assembly may comprise a holder, a backer sheet and a printed identifier tag which is insertable between the holder and the backer sheet. The printed tag may be held in alignment in the assembly between the holder and the backer sheet without the use of adhesives. The printed tag may bear the user's name or some other printed indicia. The backer sheet may be a metal plate which is held in position on the user's clothing with a small magnet.

It is known in the prior art to produce identifier tags or labels which are “dry peel”. For example, U.S. Pat. No. 6,284,338, Bauman et al., relates to label insert sheets which incorporate a dry peel feature to enable multi-pass use through a computer printer. However, the labels produced are not transparent or translucent.

The need has therefore arisen for non-adhesive transparent or translucent labels derived from a label sheet that may be passed through a printer multiple times, even after some of labels have been removed.

### SUMMARY OF INVENTION

In accordance with the invention, a multi-layer sheet is provided comprising a liner sheet having a first side and a second side, wherein the second side is coated with a dry release coating; and a plastic label sheet bonded to the second side of the liner sheet with the coating. The label sheet is cut to define a plurality of separately removable labels, wherein each of said labels is non-tacky when removed from said liner sheet. In one embodiment the label sheet is formed from transparent plastic.

In another aspect of the invention, a method of manufacturing a multi-layer sheet is provided comprising providing a liner sheet; coating one side of said liner sheet with a dry release coating; bonding a plastic label sheet to said one side of said liner sheet; and cutting the label sheet to define a plurality of separate labels, wherein each of said labels is non-tacky when removed from the liner sheet.

### BRIEF DESCRIPTION OF THE DRAWING

In a drawing which illustrates an embodiment of the invention, but which should not be construed as restricting the spirit or scope of the invention in any way,

FIG. 1 is an exploded view of a multi-layer sheet fabricated in accordance with the invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

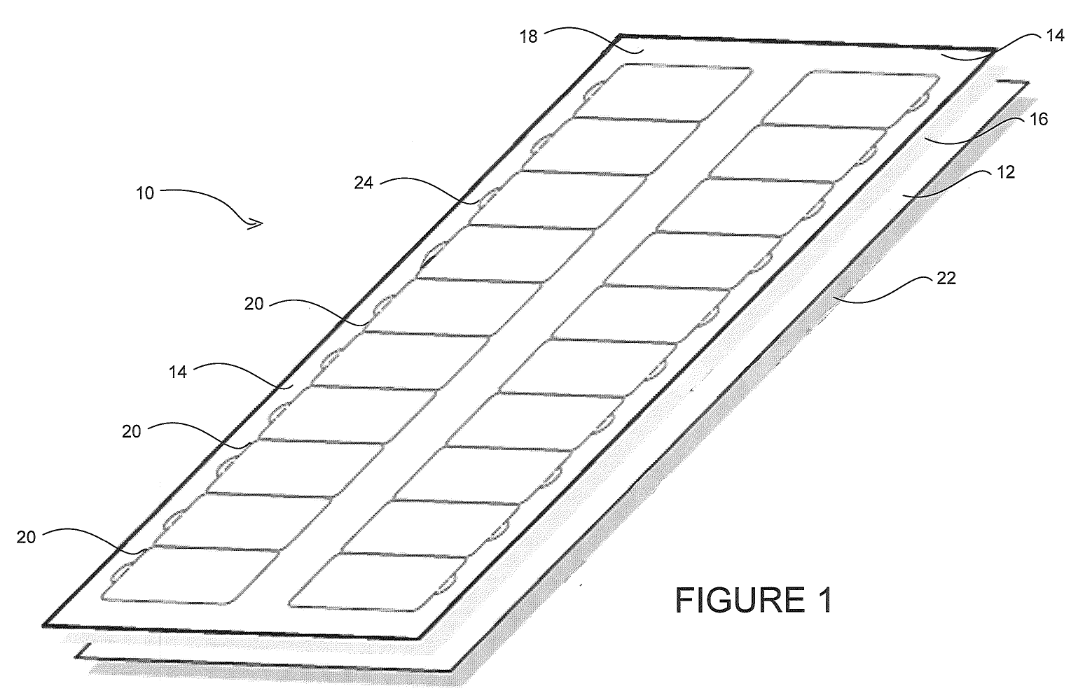

This application relates to a multi-layer sheet 10. As shown in FIG. 1, sheet 10 comprises a liner sheet 12 and a label sheet 14. Label sheet 14 is bonded to liner sheet 12 with a dry release coating 16 applied to liner sheet 12. In one embodiment, coating 16 may comprise a dry adhesive 16 which is formulated to remain on liner sheet 12 when a portion of label sheet 14 is removed from liner sheet 12. More particularly, label sheet 14 may be diecut to define a plurality of separately removable labels 20 and non-label portions 18. Once removed from liner sheet 12, each label 20 is non-tacky or “dry peel”. That is, in this embodiment of the invention, the adhesive coating 16 bonding liner sheet 12 and label sheet 14 together remains on liner sheet 12 and dries so quickly when it is exposed that neither the label 20 nor the exposed liner layer 12 is sticky to the touch.

In another embodiment of the invention, dry release coating 16 may comprise the combination of an adhesive covered with a breakaway coating. In this embodiment, the adhesive bonds the breakaway coating to liner sheet 12. As in the embodiment of the invention described above, when a label 20 is removed from the breakaway coating, it is non-tacky. The breakaway coating prevents the adhesive on the liner sheet from being exposed to ensure that the exposed liner layer is also not sticky to the touch.

As will be apparent to a person skilled in the art, many variations are possible in the formulation of dry release coating 16 without departing from the invention. In particular, coating 16 may comprise one or more different types of adhesives and coatings to achieve the dry release functionality. For example, breakaway coating may comprise any suitable controlled release, separable interface, such as a polymer-based breakaway coating.

In one embodiment of the invention, label sheet 14 may be formed from a clear plastic material. Accordingly, in this embodiment labels 20 are clear and non-adhesive. By way of example, label sheet may comprise a layer of clear polyester, such as transparent polyethylene terephthalate. Optionally a topcoat layer, such as a gloss laser topcoat, may be applied to the polyester layer. The topcoat is provided to facilitate toner anchorage and to allow single or multiple passes of label sheet 14 through a laser printer. Other suitable topcoats could be selected to anchor ink or other markings, for example when sheet 10 is used in conjunction with ink-jet or ribbon printers.

In one embodiment, label sheet 14 is approximately 4 mil in thickness. Labels 20 derived from sheet 14 may be used as inserts in an identifier tag assembly as described in Applicant's U.S. Pat. No. 6,726,252 which is hereby incorporated by reference in its entirety. That is, labels 20 may be used in conjunction with a plastic frame and a rigid metal backer sheet. The identifier tag assembly may further include a magnet or pin fastener for temporarily affixing the assembly to an article of clothing. Labels 20 may be used, for example, as part of a wearable name badge or the like. In one embodiment each label may be approximately 1 inch by 3 inches in size.

In one embodiment of the invention, liner sheet 12 may also comprise a layer of clear polyester, such as transparent polyethylene terephthalate. Optionally, a layer 22 of tissue paper may be laminated to the side of liner sheet 12 not bonded to label sheet 14. The tissue paper layer 24 may be bonded to liner sheet 12 using a laminating adhesive, such as a permanent acrylic adhesive. In one exemplary embodiment, the coat weight of the adhesive is 7-9 grams/msi. The plastic layer of liner sheet 12 may be approximately 3 mil in thickness and the tissue paper layer 22 may be 1 mil in thickness. Many variations are possible without departing from the invention as will be appreciated by a person skilled in the art.

Tissue paper layer 22 applied to liner sheet 12 is provided to assist in feeding multi-layer sheet 10 through a conventional laser or ink jet printer to print one or more labels 20 in accordance with user input. That is, layer 22 provides a surface having sufficient friction to avoid printer jams. Layer 22 also enhances the stability of liner sheet 12 during the manufacturing process and helps preventing bending or curling of sheet 10, even when it is passed through a printer multiple times.

Labels 20 may be printed with indicia such as the name or title of an employee or a corporate logo. Each sheet 10 is sufficiently flexible and heat-stable that it will not deform if passed through a printer multiple times. For example, selected labels may be printed using a computer printer in a manner similar to a conventional label sheet. The selected labels 20 may then be removed from sheet 10. As shown in FIG. 1, each label 20 may be diecut to define one or more lift assists 24 to assist a user in manually grasping a label 20 and peeling it away from liner sheet 12. Since, when exposed, the dry release coating 16 bonding liner sheet 12 and label sheet 14 together is non-tacky, sheet 10 may then be fed through the printer multiple times without causing gumming or printer jams, even with selected labels 20 removed. Accordingly, all of the labels 20 of sheet 10 do not need to be printed and used at one time. Wastage of unprinted labels 20 is therefore minimized. This is particularly important in the case of plastic labels which are relatively expensive as compared to paper labels.

In one embodiment of the invention the release value on peel strength of the dry release coating 16 is within the range of 120 g-210 g/2″ strip. In a particular embodiment of the invention the release value on peel strength is within the range of 140 g-160 g/2″ strip. One suitable release value is 150 g/2″ strip. As will be appreciated by a person skilled in the art, many variations are possible without departing from the invention.

Multi-layer sheet 10 may be manufactured in an automated laminating process. In one embodiment, tissue paper layer 22 is permanently bonded to plastic liner sheet 12 with a laminating adhesive. The side of sheet 12 not covered with layer 22 is then coated with dry release coating 16, in one or more coating steps, and is bonded to one side of label sheet 14 to form sheet 10 (FIG. 1). As indicated above, a topcoat layer may also optionally be applied to label sheet 14.

Master rolls of sheet 10 may then be slit, for example into 9 inch widths for printing purposes. The roll stock may be run through a label press and printed information or other indicia may be optionally added to it. The stock may then be diecut inline on the press in the desired configuration, for example to define multiple labels 20 and lift assists 24. The cutter is set to impart a “kisscut” through label sheet 14 but not liner sheet 12. The size and shape of the labels 20 or other product produced by the diecutting may vary depending upon the intended application. The roll stock of sheet 10 may then be slit and sheeted to produce the finished product suitably sized for printer infeed.

As will be apparent to those skilled in the art in the light of the foregoing disclosure, may alterations and modifications are possible in the practice of the invention without departing from the spirit or scope thereof. Accordingly, the scope of the invention is to be construed in accordance with the substance defined by the following claims.

What is claimed is:

1. A multi-layer sheet comprising:
(a) a liner sheet having a first side and a second side, wherein said second side is coated with a dry release coating; and
(b) a plastic label sheet bonded to said second side of said liner sheet with said dry release coating, wherein said label sheet is cut to define a plurality of separately removable labels, wherein each of said labels is non-tacky when removed from said liner sheet.

2. The multi-layer sheet as defined in claim 1, wherein said sheet may be passed through a laser printer multiple times with one or more of said labels removed.

3. The multi-layer sheet as defined in claim 1, wherein the release value on peel strength of said labels is within the range of 120 g-210 g/2″ strip.

4. The multi-layer sheet as defined in claim 3, wherein the release value on peel strength of said labels is within the range of 140 g-160 g/2″ strip.

5. The multi-layer sheet as defined in claim 4, wherein said label sheet is transparent or translucent.

6. The multi-layer sheet as defined in claim 5, wherein label sheet comprises transparent polyethylene terephthalate.

7. The multi-layer sheet as defined in claim 6, wherein said label sheet has a thickness of approximately 4 mil.

8. The multi-layer sheet as defined in claim 6, wherein said label sheet comprises a topcoat layer to facilitate anchorage of toner or ink on said label sheet.

9. The multi-layer sheet as defined in claim 1, wherein said liner sheet is transparent or translucent plastic.

10. The multi-layer sheet as defined in claim 9, wherein said liner sheet comprises transparent polyethylene terephthalate.

11. The multi-layer sheet as defined in claim 9, wherein said liner sheet has a thickness of approximately 3 mil.

12. The multi-layer sheet as defined in claim 9, comprising a tissue paper layer laminated to said first side of said liner sheet.

13. The multi-layer sheet as defined in claim 12, wherein said tissue paper sheet has a thickness of approximately 1 mil.

14. The multi-layer sheet as defined in claim 12, wherein said tissue paper sheet is bonded to said liner sheet with a laminating adhesive.

15. The multi-layer sheet as defined in claim 1, wherein said dry release coating comprises a dry adhesive.

16. The multi-layer sheet as defined in claim 1, wherein said dry release coating comprises a breakaway coating.

17. The multi-layer sheet as defined in claim 1, wherein said dry release coating comprises an adhesive bonding said breakaway coating to said liner sheet.

18. The multi-layer sheet as defined in claim 1, wherein said liner sheet is non-cut.

19. The multi-layer sheet as defined in claim 1, wherein said labels are selectively printable when said sheet is fed through a laser printer.

20. The multi-layer sheet as defined in claim 1, wherein lift assists are formed in said label sheet to assist in manually removing said labels from said liner sheet.

21. A method of manufacturing a multi-layer sheet comprising:
(a) providing a liner sheet:
(b) coating one side of said liner sheet with a dry release coating;
(c) bonding a plastic label sheet to said one side of said liner sheet; and
(d) cutting said label sheet to define a plurality of separate labels,
wherein each of said labels is non-tacky when removed from said liner sheet.

22. The method as defined in claim 21, wherein said plastic is transparent or translucent.

23. The method as defined in claim 21, comprising bonding a tissue paper layer to a side of said liner sheet opposite said one side.

24. The method as defined in claim 21, wherein said dry release coating comprises a dry adhesive.

25. The method as defined in claim 21, wherein said dry release coating comprises the combination of a breakaway coating bonded to said liner sheet with an adhesive.

26. The method as defined in claim 21, comprising cutting said sheet to a size suitable for passage through a laser printer.

27. The method as defined in claim 21, wherein said cutting comprises cutting said label sheet without cutting said liner sheet.

28. An identifier tag assembly comprising a label derived from the multi-layer sheet as defined in claim 1.

29. The assembly as defined in claim 28, wherein said label has printed indicia thereon.

30. The assembly as defined in claim 28, wherein said assembly comprises a cover and wherein said label is an insert positioned within cover.
